(19) United States
(12) Patent Application Publication
(10) Pub. No.: US 2019/0212829 A1
(43) Pub. Date: Jul. 11, 2019

(54) COMMUNICATION METHOD AND DEVICE

(71) Applicant: Alibaba Group Holding Limited, Grand Cayman (KY)

(72) Inventors: Boyu Yang, Zhejiang (CN); Hang Chen, Zhejiang (CN); Ming Zhang, Zhejiang (CN); Aisong Ren, Zhejiang (CN); Jintao Lv, Zhejiang (CN); Hailong Yao, Zhejiang (CN); Weinan He, Zhejiang (CN); Dengxian Lai, Zhejiang (CN)

(21) Appl. No.: 16/355,140

(22) Filed: Mar. 15, 2019

Related U.S. Application Data
(63) Continuation of application No. PCT/CN2017/101251, filed on Sep. 11, 2017.

(30) Foreign Application Priority Data
Sep. 18, 2016 (CN) 201610830274.2

(51) Int. Cl. G06F 3/01; G06F 3/0483; G06F 3/041; G06F 3/0481; H04L 12/58

(52) U.S. Cl. CPC G06F 3/017; G06F 3/0483; H04L 51/04; G06F 3/04817; G06F 3/041

(57) ABSTRACT

A communication method and device are provided. The method comprises: detecting a user operation aimed at a trigger element related to a reminder message function page in a communication application; executing a regular processing function corresponding to the trigger element when the user operation is a predefined regular trigger operation; and displaying a quick editing page for a reminder message when the user operation is a predefined quick trigger operation, wherein the quick editing page is used for quickly sending received user input information as content of the reminder message according to a default sending condition. By using the technical solution, a reminder message is edited and sent quickly, thereby helping simplify user operations and improving the efficiency of sending the reminder message.

### CROSS REFERENCE TO RELATED PATENT APPLICATIONS

This application claims priority to and is a continuation of PCT Patent Application No. PCT/CN2017/101251, filed on 11 Sep. 2017, which claims priority to Chinese Patent Application No. 201610830274.2 filed on 18 Sep. 2016 and entitled “COMMUNICATION METHOD AND DEVICE”, which are incorporated herein by reference in their entirety.

### TECHNICAL FIELD

The present disclosure relates to the field of communication technologies, and, more particularly, to communication methods and devices.

### BACKGROUND

In the current technology, a user may send a reminder message to a target user through a communication application. As the reminder message is transmitted, prompted, and presented in a way different from that of other communication messages, it may remind the target user to process a related task or event in time.

However, the user may only implement the creation and transmission of the reminder message by using a special function page provided by the communication application. Therefore, it takes the user a lot of energy and time to look for and switch to the special function page, thereby resulting in low efficiency of sending the reminder message.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The present disclosure provides a communication method and device, which may edit and send a reminder message quickly, thus helping simplify user operations and improving the efficiency of sending the reminder message.

The present disclosure provides the following technical solutions:

according to an aspect of the present disclosure, a communication method is provided, including:

detecting a user operation aimed at a trigger element related to a reminder message function page in a communication application;

executing a regular processing function corresponding to the trigger element when the user operation is a predefined regular trigger operation; and

displaying a quick editing page for a reminder message when the user operation is a predefined quick trigger operation, wherein the quick editing page is used for quickly sending received user input information as content of the reminder message according to a default sending condition.

According to another aspect of the present disclosure, a communication device is provided, including:

a detecting unit configured to detect a user operation aimed at a trigger element related to a reminder message function page in a communication application;

an executing unit configured to execute a regular processing function corresponding to the trigger element when the user operation is a predefined regular trigger operation; and

a displaying unit configured to display a quick editing page for a reminder message when the user operation is a predefined quick trigger operation, wherein the quick editing page is used for quickly sending received user input information as content of the reminder message according to a default sending condition.

As shown from the foregoing technical solution, in the present disclosure, a user's requirement for creating a reminder message is determined accurately by detecting a user operation aimed at a trigger element related to a reminder message function page and identifying an operation type of the user operation. Meanwhile, a quick editing page is displayed to the user when the user operation is a predefined quick trigger operation, so that the user edits and creates a reminder message quickly without spending a lot of energy and time to look for a special function page for a reminder message, thereby helping simplify user operations and improving efficiency of sending the reminder message.

### BRIEF DESCRIPTION OF THE DRAWINGS

The accompanying drawings described herein are used to enable further understanding of the present disclosure and constitute a part of the present disclosure. Example embodiments of the present disclosure are used to explain the present disclosure, and are in no way intended to improperly limit the present disclosure. In the drawings:

FIG. 1 to FIG. 3 are schematic diagrams of pages related to creation of a reminder message in the current technologies;

FIG. 4 is a flowchart of a communication method according to an example embodiment of the present disclosure;

FIG. 5 is a flowchart of another communication method according to an example embodiment of the present disclosure;

FIG. 6 to FIG. 9 are schematic diagrams of pages related to quick creation of a reminder message according to an example embodiment of the present disclosure;

FIG. 10 is a flowchart of another communication method according to an example embodiment of the present disclosure;

FIG. 11 to FIG. 13 are schematic diagrams of another type of pages related to quick creation of a reminder message according to an example embodiment of the present disclosure;

FIG. 14 is a schematic structural diagram of an electronic device according to an example embodiment of the present disclosure; and

FIG. 15 is a block diagram of a communication device according to an example embodiment of the present disclosure.

### DETAILED DESCRIPTION

In current technologies, a communication application may support creation, transmission, and presentation of a reminder message. On one hand, the reminder message may be sent in many manners such as instant messaging, SMS, and voice over telephone to achieve a better reminding effect. On the other hand, the communication application provides a special function page for the reminder message to distinguish from other communication messages supported by the communication application, thereby achieving a better reminding effect.

The following descriptions may use the Enterprise Instant Messaging (EIM) application such as “DING Talk” as an example. In some examples, the mail in the DING Talk is referred to as Ding mail and the message in the DING Talk is referred to as DING Message or DING. The methods and devices, as described in the DING Talk, may be applied to any other communication application, device, and method.

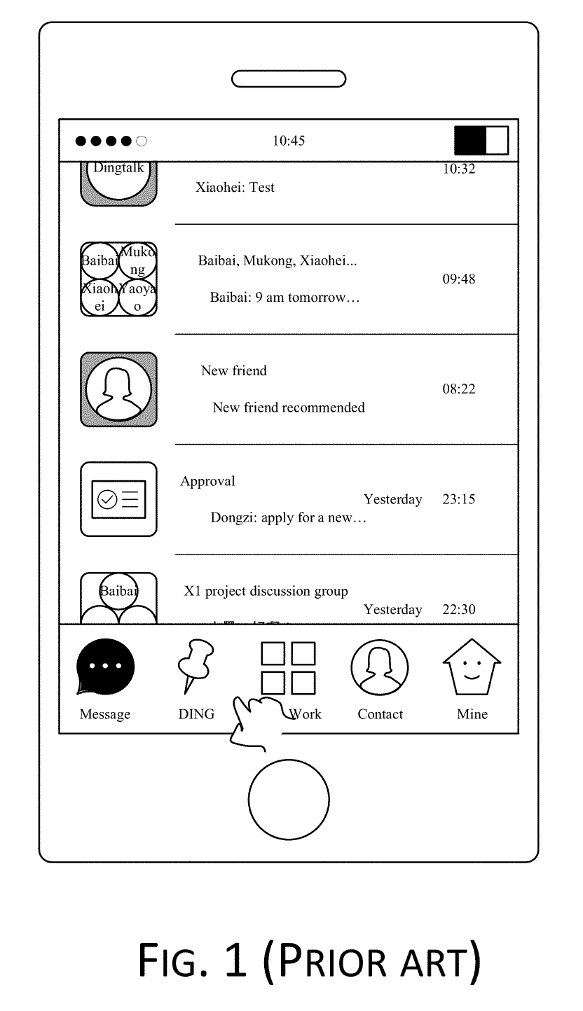

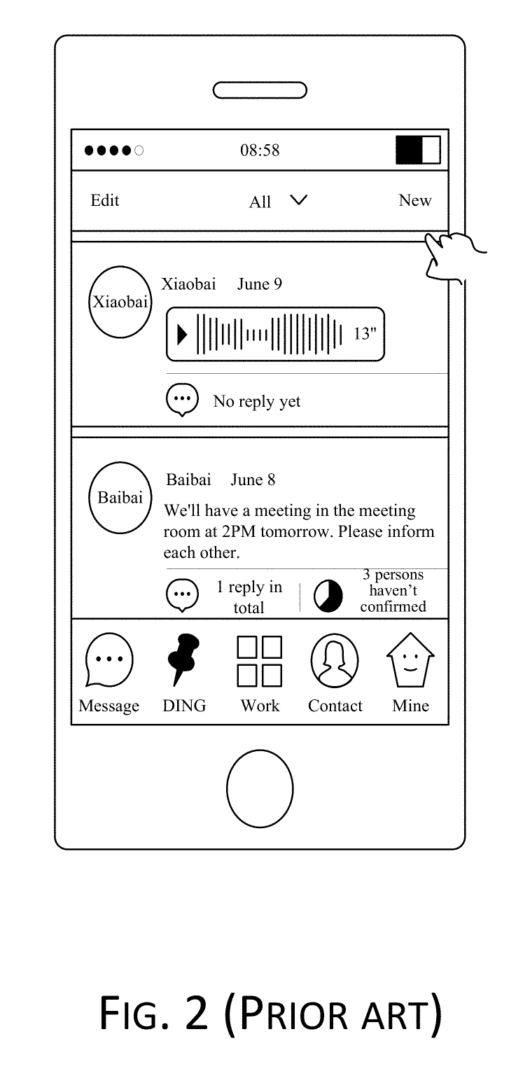

A DING Talk client terminal may provide multiple tabs such as “Message,” “DING” and the like displayed in FIG. 1. “Message” corresponds to a message list page that is used for presenting other communication messages except the reminder message, for example, an instant messaging message corresponding to a group “Baibai, Mukong, Xiaohei . . . ,” a friend recommending message corresponding to “new friend,” an approval message corresponding to an enterprise management function “approval” included in DING Talk, and so on. “DING” corresponds to the reminder message presentation page displayed in FIG. 2, which is specially used for presenting the reminder message supported by DING Talk, i.e., “DING message.”

A user may implement functions such as page switching in the related art by using a regular trigger operation. For example, assuming that the regular trigger operation is a click operation (such as single click), the message list page displayed in FIG. 1 may be switched to the reminder message presentation page displayed in FIG. 2 when the user clicks a first entry identifier presented by the “DING” tab displayed in FIG. 1, i.e., the text “DING” or the “pushpin” icon displayed at the bottom of FIG. 1. Similarly, the reminder message presentation page displayed in FIG. 2 may be switched to the message list page displayed in FIG. 1 when the user clicks an entry identifier presented by the “Message” tab displayed in FIG. 2, i.e., the text “Message” or “Session” icon at the bottom of FIG. 2. In other words, switching between function pages corresponding to tabs may be performed by performing a regular trigger operation on each tab at the bottom of FIG. 1 or FIG. 2.

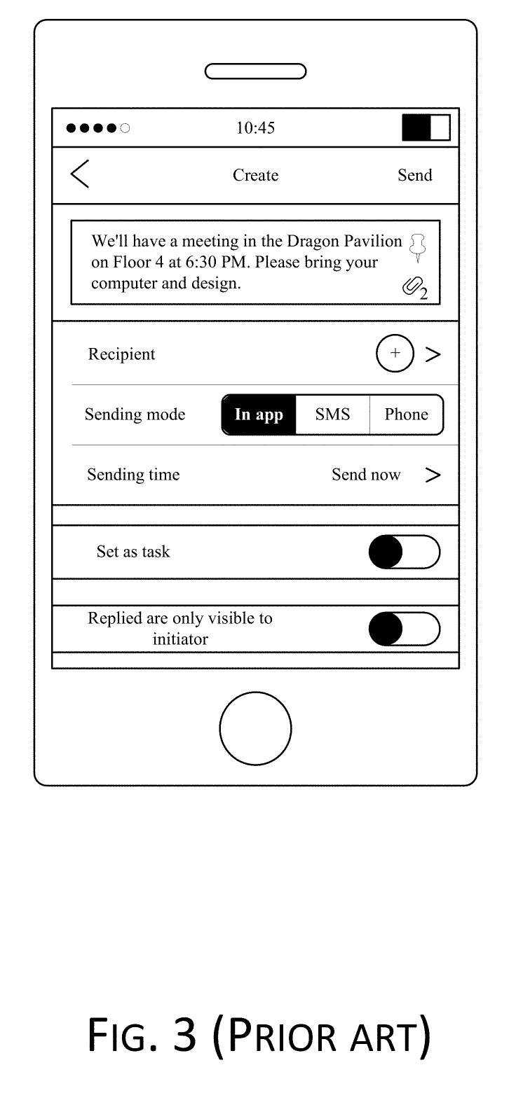

In the reminder message presentation page displayed in FIG. 2, the user may also create a new reminder message actively in addition to viewing a generated reminder message. For example, the user may perform a regular trigger operation on a second entry identifier included in the reminder message presentation page, i.e., the text “Create” on the upper right corner of FIG. 2, to switch to the normal editing page displayed in FIG. 3, such that the user may edit, generate and send a reminder message.

In the normal editing page displayed in FIG. 3, the user may input message content of a reminder message through an input field at the top. Moreover, a mode switching identifier (which is displayed as a “pushpin” icon in FIG. 3, but is not limited in the present disclosure) is provided on the upper right corner of the input field, and the user may configure the reminder message to be in a pin-to-top mode or a common mode. Besides, a clip icon and the number 2 on the right side of the icon are provided on the lower right corner of the input field, indicating that 2 attachments have been added. In addition, the user further needs to configure “Recipient (i.e., a receiver or a target object),” a “Sending mode (“In app” corresponds to an instant messaging message; “SMS” corresponds to an SMS message; and “Phone” corresponds to voice over telephone),” “Sending time,” “Set as task (a reminder message of a “Task” type has a task deadline, and the receiver needs to feed task performance back before the task deadline),” “Replies are only visible to initiator (after the function is enabled, multiple receivers cannot view each other's reply messages, and only the sender may view all the reply messages),” and the like of the corresponding reminder message through the normal editing page.

It may be seen that when a user creates a reminder message based on the related art, it takes a lot of energy and time to look for the first entry identifier, the second entry identifier and the like on one hand, and on the other hand, the user needs to configure many items of the reminder message one by one, thus causing problems of complex user operations and low efficiency.

Therefore, the present disclosure improves a creation process of the reminder message to solve the foregoing problems in the related art. The following example embodiments are provided to further illustrate the present disclosure:

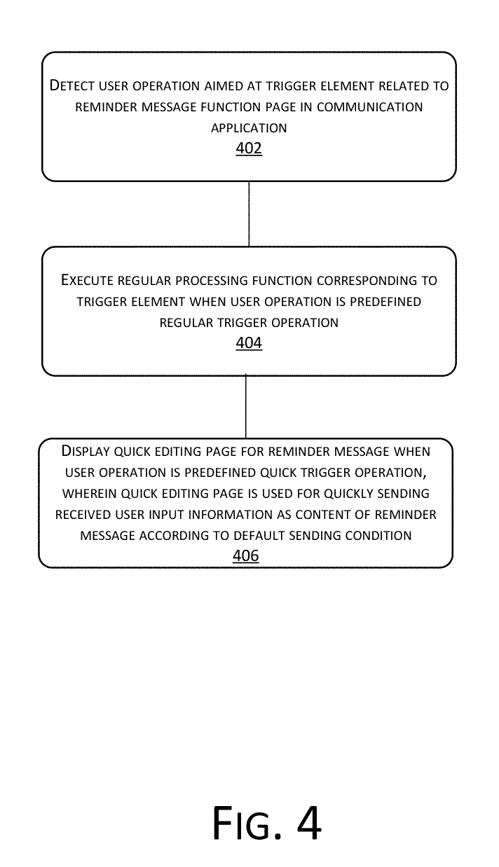

FIG. 4 is a flowchart of a communication method according to an example embodiment of the present disclosure. As shown in FIG. 4, the method is applied to an electronic device and may include the following steps:

Step 402: A user operation aimed at a trigger element related to a reminder message function page in a communication application is detected.

In this example embodiment, the communication application may be any application supporting a communication function. For example, when the communication application includes an instant messaging application, the instant messaging application may be the foregoing enterprise instant messaging application, such as DING Talk, which is not limited in the present disclosure.

In an example embodiment, the trigger element related to the reminder message function page may include a trigger element for switching to the reminder message function page, for example, a first entry identifier represented by the text “DING” or the “pushpin” icon displayed in FIG. 1.

In another example embodiment, the trigger element related to the reminder message function page may include a trigger element in the reminder message function page, for example, a second entry identifier represented by the text “Create” displayed in FIG. 2.

Step 404: A regular processing function corresponding to the trigger element is executed when the user operation is a predefined regular trigger operation.

Step 406: A quick editing page for a reminder message is displayed when the user operation is a predefined quick trigger operation, wherein the quick editing page is used for quickly sending received user input information as content of the reminder message according to a default sending condition.

In this example embodiment, types of user operations are distinguished so that original trigger elements may be reused without adding more trigger elements in the communication application, thus realizing multiple application functions based on the same trigger element without increasing the complexity of content of the communication application. For example, the regular trigger operation is used for realizing a regular function in the current technology, and the quick trigger operation is used for realizing a quick function in the present disclosure, to meet application requirements of the user in different scenarios.

The regular trigger operation and the quick trigger operation may be any different trigger operations, which are not limited in the present disclosure. For example, when the regular trigger operation is a click operation for the trigger element, the quick trigger operation may be a long-press operation for the trigger element; or when the regular trigger operation is a tap operation for the trigger element, the quick trigger operation may be a hit operation for the trigger element.

In this example embodiment, the trigger element is related to the reminder message function page. Therefore, when the quick editing page for the reminder message is displayed upon detection of the quick trigger operation, on one hand, the quick trigger operation in the present disclosure does not seem abrupt and may be easily accepted by the user as the quick editing page is related to the reminder message function page, and on the other hand, the user may understand, memorize, and constantly use the quick trigger operation easily, thus reducing the learning cost and using threshold for the user.

In an example embodiment, when the trigger element includes a first entry identifier of the reminder message function page in the communication application, the reminder message function page may be switched to according to the detected regular trigger operation for the first entry identifier, especially in the case where the reminder message function page is not displayed currently; and the quick editing page for the reminder message may be displayed according to the detected quick trigger operation for the first entry identifier, especially in the case where the reminder message function page is not displayed currently, so that the user may edit, generate and send the reminder message quickly.

In another example embodiment, when the trigger element includes a second entry identifier of a normal editing page for the reminder message, the normal editing page for the reminder message may be displayed according to the detected regular trigger operation for the second entry identifier, so as to determine content of the reminder message according to user input information received in the reminder message function page and complete user configuration for the sending condition. Then, the content of the reminder message is sent normally according to the user-configured sending condition. Moreover, the quick editing page for the reminder message may be displayed according to the detected quick trigger operation for the second entry identifier, so that the user may edit, generate and send the reminder message quickly.

In this example embodiment, the operation of sending the reminder message requires two types of data: message content and sending condition. The message content may be actively input by the user, and includes information such as a text, a picture, a video, a file and the like. The sending condition may include a receiver of the reminder message and a message type of the reminder message. In the normal editing page, the user needs to edit the message content and the sending condition manually, and the operations are complex. In the quick editing page, the user only needs to edit the message content manually, and does not need to configure the sending condition, thus significantly simplifying user operations and improving the efficiency of sending the reminder message.

A default sending condition may be set in the communication application. Alternatively, the user may manually configure the sending condition in advance, so that the reminder message is sent by using the configured sending condition during subsequent processing carried out through the quick editing page. For example, the receiver of the reminder message may be a sender of the reminder message or an associated member (such as a member in the same working group in an enterprise) in a group (for example, an enterprise, a school, a government agency, armed police forces, and the like) to which the sender belongs, or the like by default. The reminder message may be sent by using an instant messaging type by default.

In this example embodiment, when the quick editing page includes a mode switching identifier, such as the “pushpin” icon on the upper right corner displayed in FIG. 3, the reminder message may be configured to be in a corresponding presentation mode according to a trigger operation for the mode switching identifier. A reminder message in a pin-to-top mode is presented in a first presentation area in a reminder message presentation page corresponding to a receiver, a reminder message in a common mode is presented in a second presentation area in a reminder message presentation page corresponding to a receiver, and the first presentation area is different from the second presentation area. For example, the first presentation area may be located at the top of the reminder message presentation page, and the second presentation area may be located below the first presentation area, so that the user may always view the pin-to-top reminder message in the first presentation area first. As such, the pin-to-top reminder message has a better reminding effect and will not be submerged by other common reminder messages on the timeline.

In this example embodiment, the quick editing page may be displayed in a temporary pop-up window, so that the quick editing page has a lightweight characteristic conforming to the “shortcut,” less content on an initial page invoking the quick editing page is obstructed, and content separation from the initial page is alleviated. As such, the user operations have better relevance and continuity. Further, the temporary pop-up window may be closed automatically after the reminder message is sent, thereby returning to the corresponding initial page actively, such that the relevance with the initial page may be further enhanced and user operations may be further simplified by automatically closing the temporary pop-up window.

It may be seen from the foregoing technical solution that in the present disclosure, a user's requirement for creating a reminder message may be determined accurately by detecting a user operation aimed at a trigger element related to a reminder message function page and identifying an operation type of the user operation. Meanwhile, a quick editing page is displayed to the user when the user operation is a predefined quick trigger operation, so that the user may edit and create a reminder message quickly without spending a lot of energy and time on looking for a special function page for a reminder message, thereby helping simplify user operations and improving the efficiency of sending the reminder message.

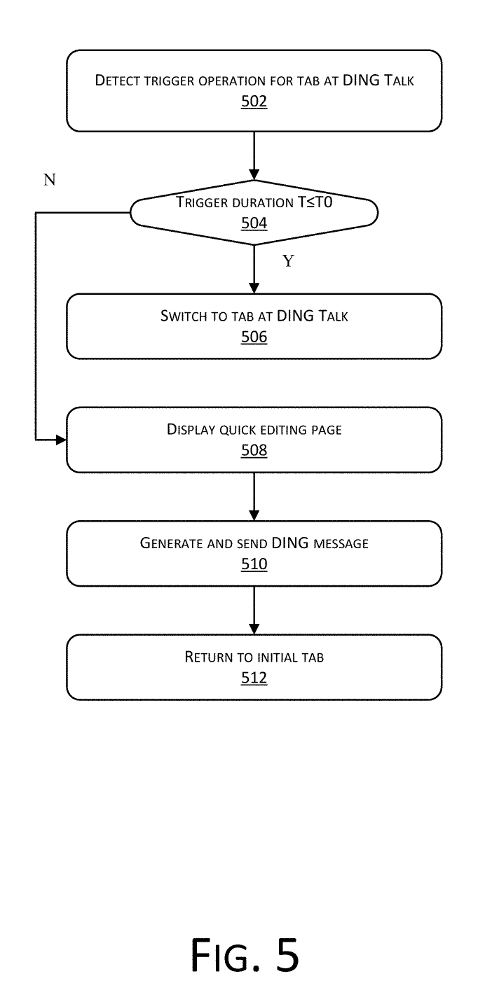

For ease of comprehension, a communication process of the enterprise instant messaging application DING Talk in an enterprise scenario is used as an example to describe the technical solution of the present disclosure in detail with reference to FIG. 5. FIG. 5 is a flowchart of another communication method according to an example embodiment of the present disclosure. As shown in FIG. 5, the method is applied to an electronic device. A DING Talk client terminal is installed on the electronic device, and the DING Talk client terminal implements functions such as page presentation and switching, reminder message generation and presentation and the like of the present disclosure during running. The method may include the following steps:

Step 502: A trigger operation for a tab at DING Talk is detected.

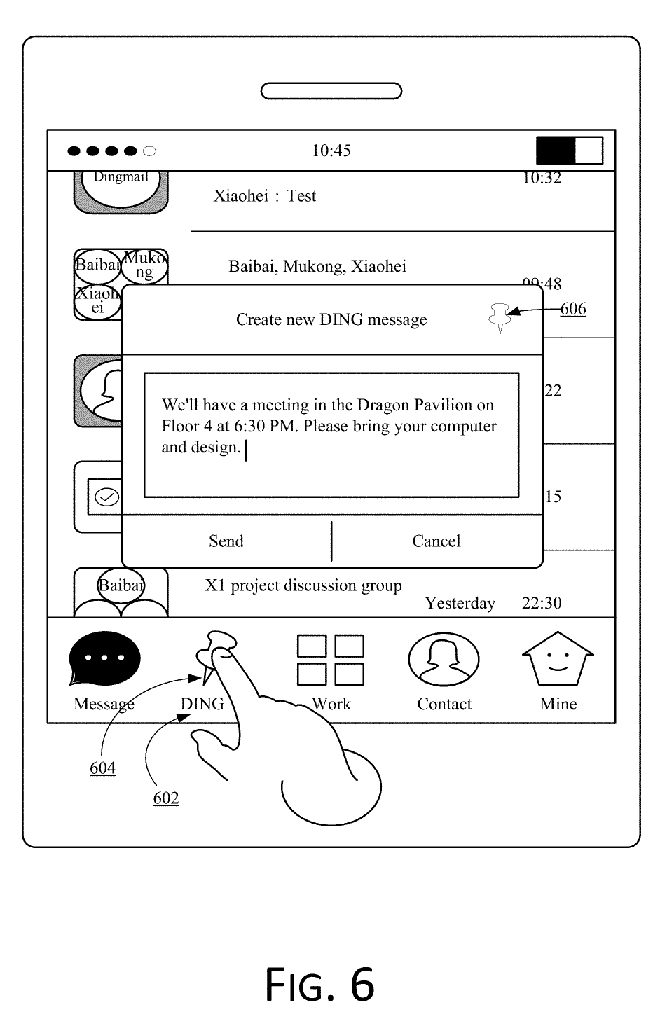

In this example embodiment, as shown in FIG. 6, when a user is on a message list page corresponding to a “Message” tab, a trigger operation for a “DING” message tab may be detected. For example, the trigger operation may be a touch operation for a first entry identifier of the “DING” message tab, and the first entry identifier may include the text “DING” 602 and “pushpin” icon 604 displayed in FIG. 6, and so on.

Step 504: Step 506 is performed when trigger duration T≤predefined standard duration T0; otherwise, step 508 is performed.

In this example embodiment, the type of the trigger operation of the user may be determined according to a numerical relationship between the trigger duration T and the predefined standard duration T0. When T≤T0, it indicates that the trigger operation is a click operation, and when T>T0, it indicates that the trigger operation is a long-press operation.

Step 506: The tab at DING Talk is switched to.

In this example embodiment, when the detected trigger operation is a click operation, a “DING” tab may be switched to using a processing method in the current technology, that is, the reminder message presentation page displayed in FIG. 2 is displayed.

Step 508: A quick editing page is displayed.

In this example embodiment, when the detected trigger operation is a long-press operation, a quick editing page for a reminder message (such as a DING message) may be displayed through the temporary window displayed in FIG. 6. As shown in FIG. 6, in the quick editing page, the user only needs to input message content in the input field, while sending conditions such as a receiver, a message type and the like are all configured by default, and the user does not need to configure the sending conditions manually. Therefore, user operations are simplified and the efficiency of processing the reminder message is improved.

Step 510: A DING message is generated and sent.

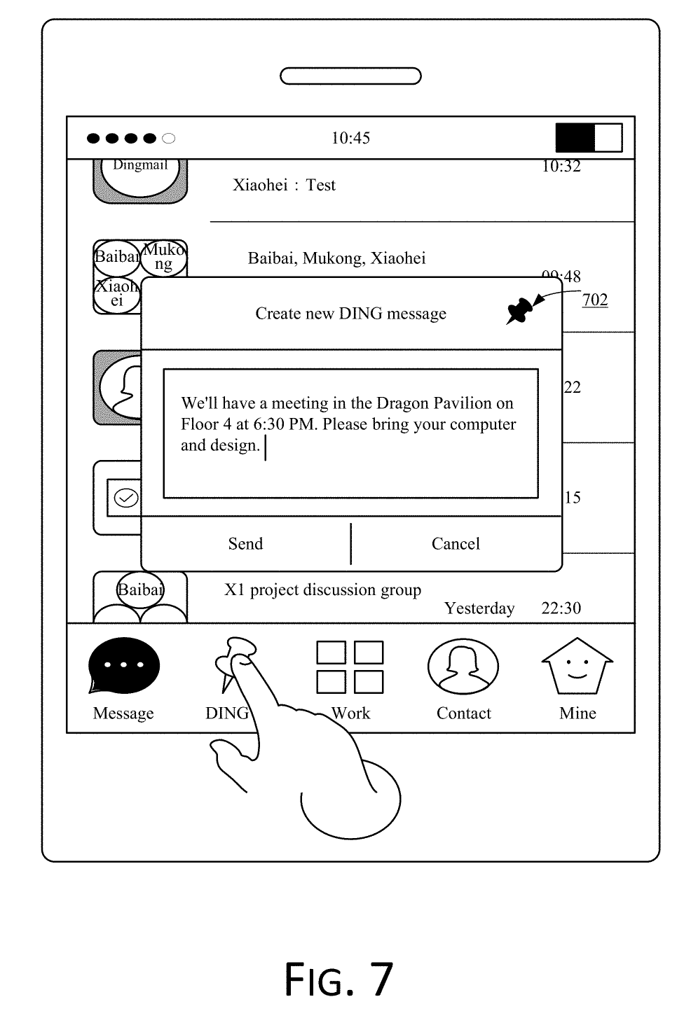

In this example embodiment, a mode switching identifier may be displayed in the quick editing page. For example, the mode switching identifier may be the “pushpin” icon displayed in FIG. 6. In the example embodiment displayed in FIG. 6, the mode switching identifier may be in a first identifier icon state 606 (such as non-pinned state) by default, indicating that the corresponding reminder message is in a common mode. When the user performs a trigger operation, such as a click, for the mode switching identifier, the mode switching identifier may be switched to a second identifier icon state 702 (such as a pinned state) displayed in FIG. 7, indicating that the corresponding reminder message is in a pin-to-top mode.

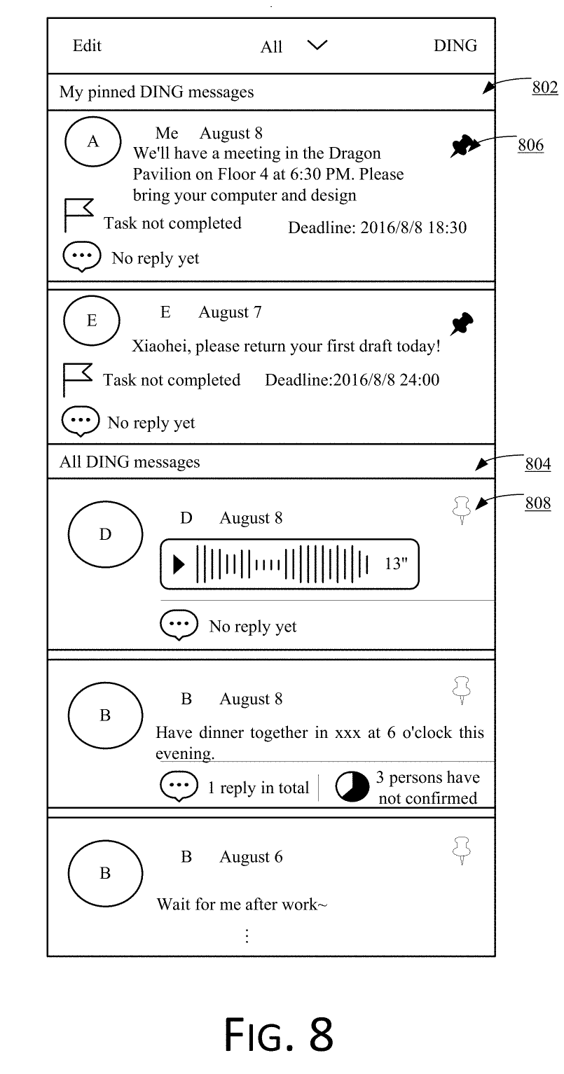

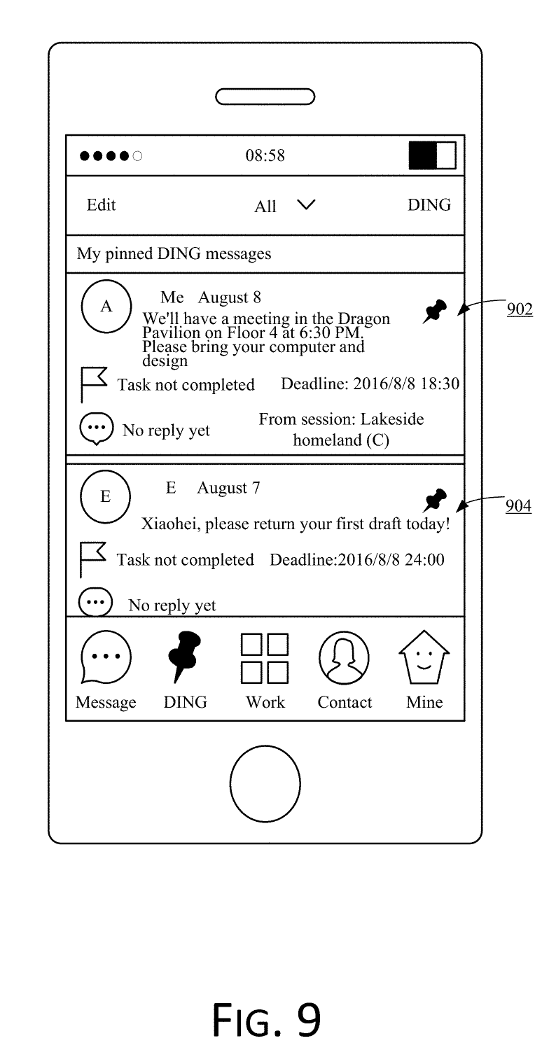

For example, the receiver is the sender by default. After the user clicks the “Send” button, the reminder message generated through the quick processing page may be received and presented on his/her own reminder message presentation page. For example, FIG. 8 is a schematic diagram of a reminder message presentation page according to an example embodiment. The reminder message presentation page displayed in FIG. 8 includes two areas: a first presentation area 802 is “My pinned DING messages” area at the top, which is always located at the top of the reminder message presentation page to display pin-to-top reminder messages at the top; a second presentation area 804 is “All DING messages” area located below the “My pinned DING messages” area. The “All DING messages” area is always located below the “My pinned DING messages” area to display common reminder messages. Further, it may be seen with reference to FIG. 9 that an important reminder message is configured as a pin-to-top reminder message, such that the user may always view the pin-to-top reminder message displayed at the top first even if a screen may only display some of reminder messages due to a limited size of the electronic device. Even if some of pin-to-top reminder messages cannot be displayed on the screen of the electronic device directly, for example, FIG. 9 only displays two pin-to-top reminder messages 902 and 904 at the top while there may be a total of three pin-to-top reminder messages actually, the user only needs to scroll the reminder message presentation page a bit to view the third pin-to-top reminder message. It is unnecessary to scroll the reminder message presentation page by a large margin to look for the reminder message, so that the user may view and process the reminder message more quickly and conveniently, thus helping improve the user's efficiency of processing the reminder message.

As shown in FIG. 8, an identifier corresponding to a presentation mode of the reminder message may be displayed in a presentation area of the reminder message. For example, in a presentation area of a pin-to-top reminder message, a first identifier 806 corresponding to a pin-to-top mode may be displayed, and in a presentation area of a common reminder message, a second identifier 808 corresponding to a common mode may be displayed.

The first identifier should be different from the second identifier, so that reminder messages of different types may be distinguished quickly and effectively. For example, the first identifier 806 may include a pushpin icon in a pinned state, and the second identifier 808 may include a pushpin icon in a non-pinned state. In this case, for the user, the pin-to-top reminder message looks like a corresponding reminder message “pinned” in the first presentation area 802 with the “pushpin,” and the common reminder message looks like a corresponding reminder message released to the second presentation area 804 after the “pushpin” is pulled out. As such, the “pin to top” and “not pin to top” may provide a more intuitive and lively visual effect and using experience.

As shown in FIG. 8 and FIG. 9, multiple pin-to-top reminder messages may coexist. Then, the pin-to-top reminder messages may be arranged according to their corresponding receiving order. Certainly, the pin-to-top reminder messages may also be arranged using other methods. For example, when the pin-to-top reminder messages are of a task type, they may be arranged according to a corresponding deadline order, which is not limited in the present disclosure.

In this example embodiment, to help the user view the pin-to-top reminder message more conveniently, details of the pin-to-top reminder message may be presented in the reminder message presentation page, while the common reminder message may be displayed in a thumbnail manner. For example, the DING Talk client terminal may conduct intelligent analysis on a triggered communication message and may configure a generated reminder message to be a task-type reminder message when identifying deadline information included in message content, wherein the deadline information is configured as a task deadline of the reminder message. The task type has a task attribute; a corresponding receiver needs to feed task performance back corresponding to the reminder message, and the receiver may receive an intelligent reminder before the task deadline.

In this case, when the reminder message is of a task type, as shown in FIG. 8, in the case of a pin-to-top reminder message, task information of the pin-to-top reminder message may be presented directly. For example, task performance (such as “task not completed”), a task deadline (such as deadline: 2016/8/8 18:30) and the like may be presented, such that the user may directly view related information of the pin-to-top reminder message without performing other operations. In the case of a common reminder message, task information of the common reminder message may be hidden. In this case, each common reminder message occupies a smaller presentation area, such that more common reminder messages are displayed at the same time in the screen of the electronic device. As such, when scrolling the reminder message presentation page by a large margin, the user may view concerned common reminder messages more conveniently and quickly, thus improving the user's efficiency of viewing and processing the common reminder messages. Certainly, the user may trigger a common reminder message, for example, click the common reminder message; then a corresponding detail page may be presented, and task information of the common reminder message is presented in the detail page.

Step 512: Then initial tab is returned to.

In this example embodiment, after the reminder message is sent or canceled, the quick editing page may be closed automatically without requiring the user to trigger closing of the page manually, which helps simplify user operations and helps the user to return to the previous initial tab quickly, for example, return to the message list page displayed in FIG. 6 or FIG. 7.

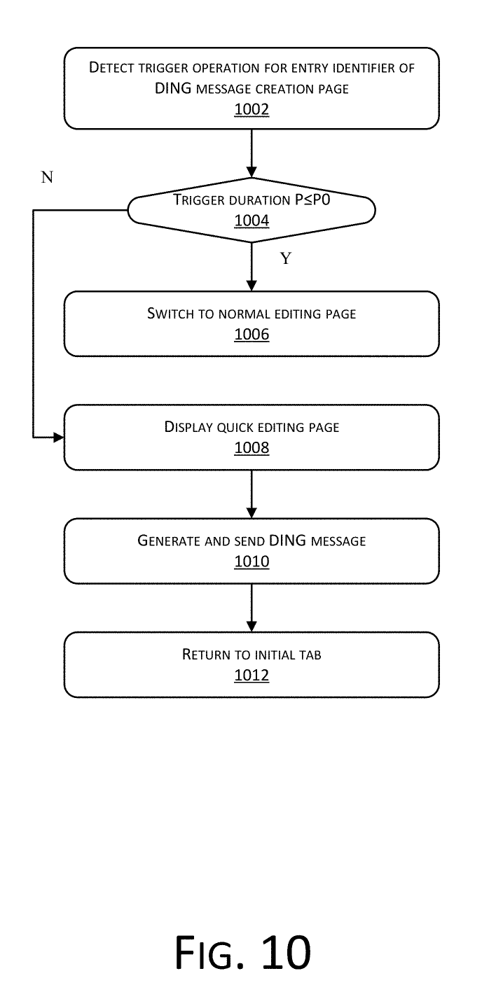

Similar to FIG. 5, FIG. 10 is flowchart of another communication method according to an example embodiment of the present disclosure. As shown in FIG. 10, the method is applied to an electronic device. A DING Talk client terminal is installed on the electronic device, and the DING Talk client terminal implements functions such as page presentation and switching, reminder message generation and presentation and the like of the present disclosure during running. The method may include the following steps:

Step 1002: A trigger operation for an entry identifier of a DING message creation page is detected.

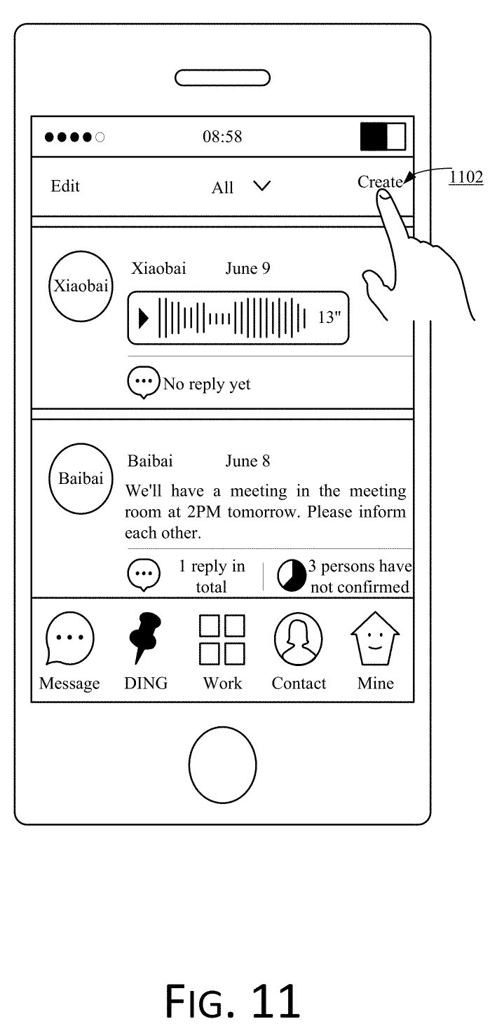

In this example embodiment, as shown in FIG. 11, when a user is in a reminder message presentation page corresponding to a “DING” tab, a trigger operation may be performed on a second entry identifier, which is in the reminder message presentation page, of a normal editing page for a reminder message. For example, the second entry identifier 1102 may include the text “Create” on the upper right corner (or other places) of the page displayed in FIG. 11.

Step 1004: Step 1006 is performed when trigger pressure P≤predefined standard pressure P0; otherwise, step 1008 is performed.

In this example embodiment, the type of the trigger operation of the user may be determined according to a numerical relationship between the trigger pressure P and the predefined standard pressure P0. When P≤P0, it indicates that the trigger operation is a tap operation, and when P>P0, it indicates that the trigger operation is a hit operation.

Step 1006: A normal editing page for a DING message is switched to.

In this example embodiment, when the detected trigger operation is a tap operation, the normal editing page for a DING message displayed in FIG. 3 may be switched to using a processing method in the current technology.

Step 1008: A quick editing page is displayed.

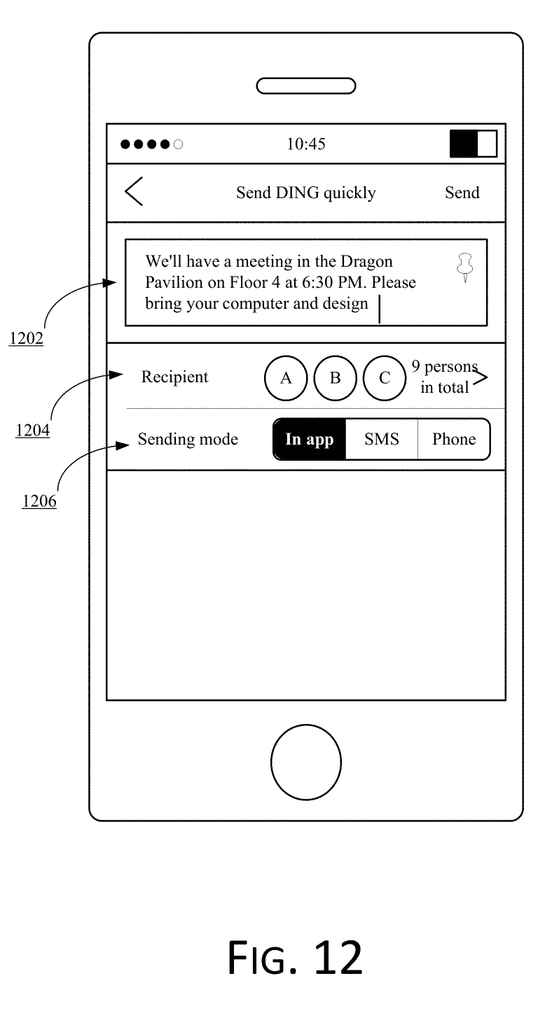

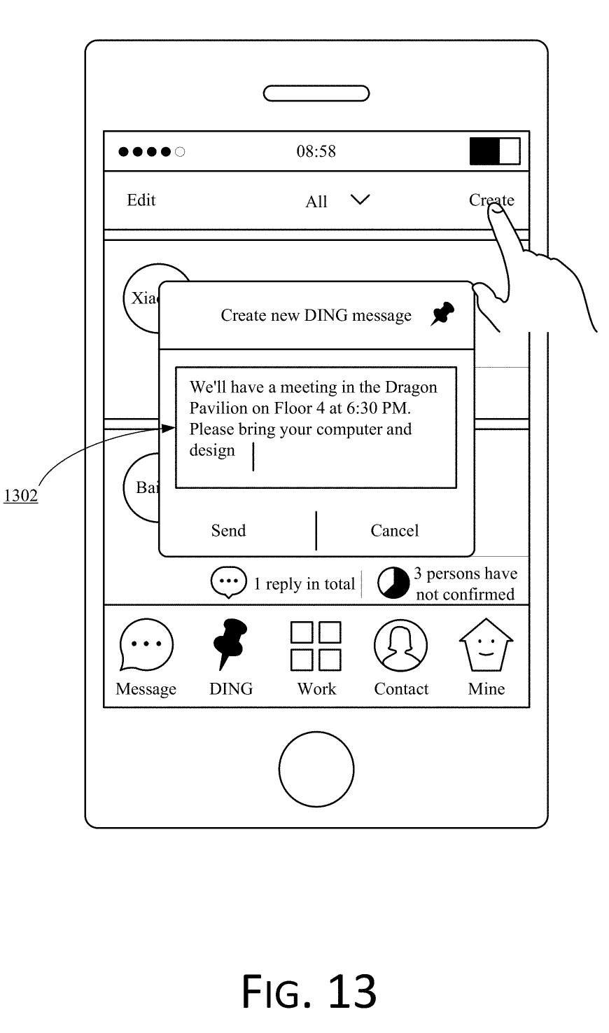

In this example embodiment, when the detected trigger operation is a hit operation, a quick editing page for a DING message displayed in FIG. 12 may be switched to. As shown in FIG. 12, the quick editing page 1202 for a DING message may be an independent page and is not necessarily presented in the temporary window displayed in FIG. 6, which is not limited in the present disclosure. Certainly, the processing method based on the temporary window is also applicable to this example embodiment. For example, FIG. 13 displays a quick editing page 1302 that is displayed in a temporary window, and details are not described here again.

As shown in FIG. 12, in the quick editing page, sending conditions may be default data: the “Recipient” 1204 may be all members in the same working group in an enterprise to which the sender belongs by default, which include a total of 9 persons including member A, member B, member C, and so on, and the “sending mode” 1206 may be an “in app” instant messaging type by default. Certainly, as the independent page displayed in FIG. 12 has a large display space, the foregoing “Recipient,” “Sending mode” and the like may be presented in the quick editing page, so that the sender may modify the configuration according to an actual requirement or directly send the corresponding DING message without modification. As such, user operations are simplified, and the efficiency of processing the reminder message is improved.

Step 1010: A DING message is generated and sent.

Step 1012: An initial tab is returned to.

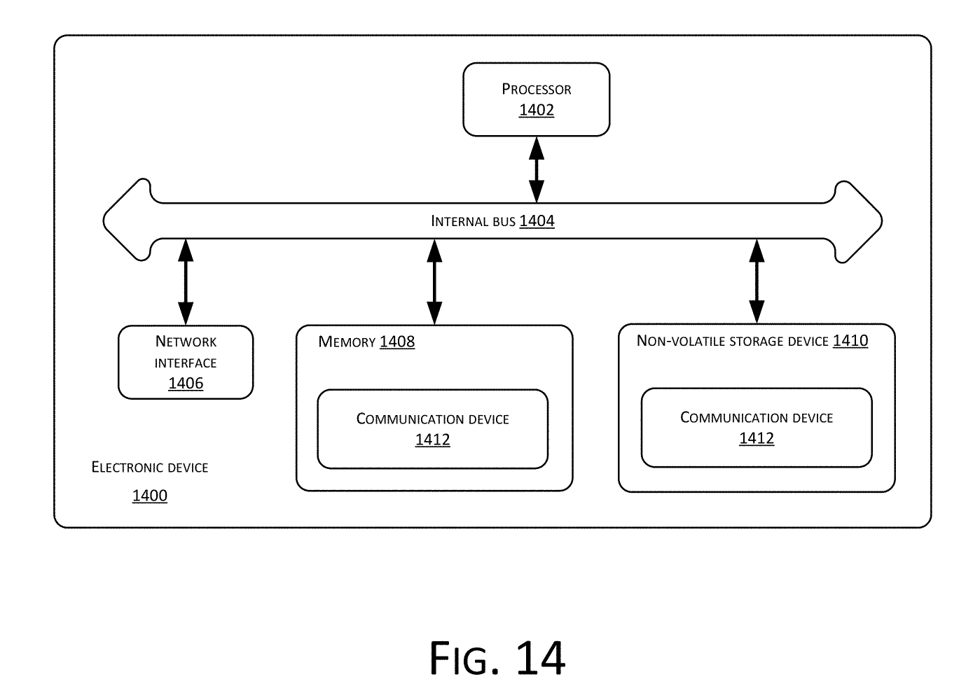

FIG. 14 is a schematic structural diagram of an electronic device according to an example embodiment of the present disclosure. Referring to FIG. 14, on the hardware level, the electronic device 1400 includes a processor 1402, an internal bus 1404, a network interface 1406, a memory 1408 and anon-volatile storage device 1410, and certainly may further include other hardware required by services. The processor 1402 reads a corresponding computer program from the non-volatile storage device 1410 to the memory 1408 and then runs the computer program to form a communication device 1412 on the logic level. Certainly, apart from the software implementation, the present disclosure does not exclude other implementations such as logic devices or a combination of software and hardware. In other words, an entity executing the following processing procedure is not limited to various logic units, but also may be hardware or logic devices.

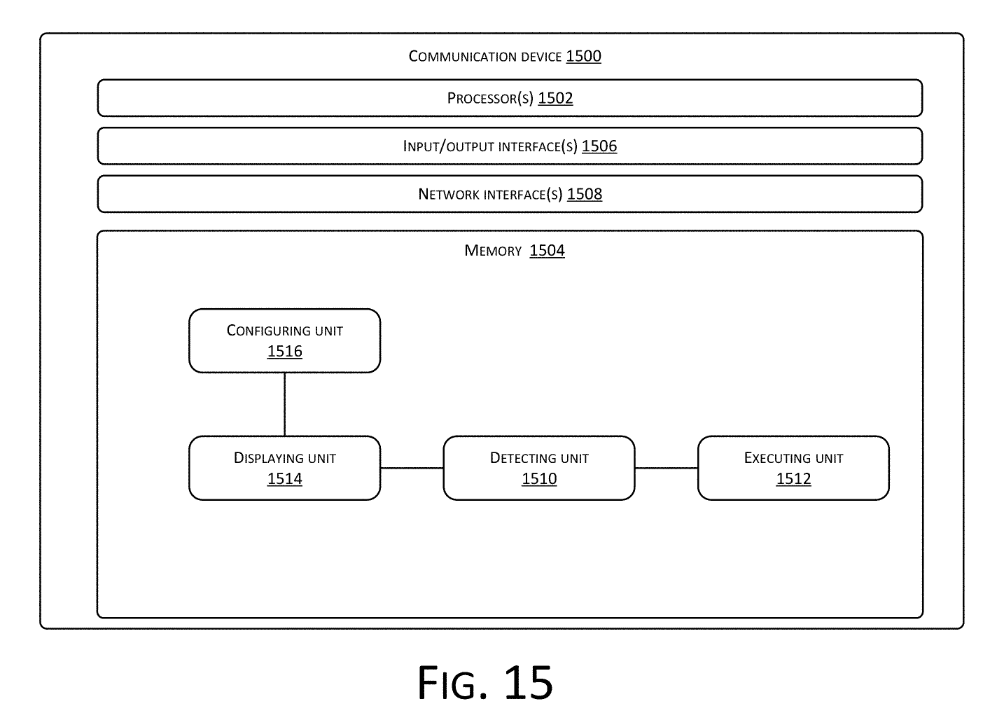

Referring to FIG. 15, a communication device 1500 may include one or more processor(s) 1502 or data processing unit(s) and memory 1504. The communication device 1500 may further include one or more input/output interface(s) 1506 and one or more network interface(s) 1508. The memory 1504 is an example of computer readable medium or media.

The memory 1504 may store therein a plurality of modules or units including a detecting unit 1510, an executing unit 1512, and a displaying unit 1514.

The detecting unit 1510 is configured to detect a user operation aimed at a trigger element related to a reminder message function page in a communication application.

The executing unit 1512 is configured to execute a regular processing function corresponding to the trigger element when the user operation is a predefined regular trigger operation;

The displaying unit 1514 is configured to display a quick editing page for a reminder message when the user operation is a predefined quick trigger operation, wherein the quick editing page is used for quickly sending received user input information as content of the reminder message according to a default sending condition.

Optionally, the regular trigger operation includes a click operation for the trigger element; and the quick trigger operation includes a long-press operation for the trigger element; or

the regular trigger operation includes a tap operation for the trigger element; and the quick trigger operation includes a hit operation for the trigger element.

Optionally, the executing unit 1512 is configured to:

switch to the reminder message function page according to the detected regular trigger operation when the trigger element includes a first entry identifier of the reminder message function page in the communication application.

Optionally, the executing unit 1512 is configured to:

display a normal editing page for the reminder message according to the detected regular trigger operation when the trigger element includes a second entry identifier of the normal editing page for the reminder message, wherein the second entry identifier is located in the reminder message function page;

determine content of the reminder message according to user input information received in the reminder message function page, and complete user configuration for a sending condition; and

send the content of the reminder message normally according to the user-configured sending condition.

Optionally, the sending condition includes a receiver of the reminder message and a message type of the reminder message.

Optionally, the receiver of the reminder message is a sender of the reminder message by default.

Optionally, the communication device 1500 further includes the following unit stored in the memory 1504:

a configuring unit 1516 configured to, when the quick editing page includes a mode switching identifier, configure the reminder message to be in a corresponding presentation mode according to a trigger operation for the mode switching identifier,

wherein a reminder message in a pin-to-top mode is presented in a first presentation area in a reminder message presentation page corresponding to a receiver, a reminder message in a common mode is presented in a second presentation area in a reminder message presentation page corresponding to a receiver, and the first presentation area is different from the second presentation area.

Optionally, the displaying unit 1514 is configured to display the quick editing page in a temporary pop-up window which is closed automatically after the reminder message is sent.

In a typical configuration, the computing device includes one or more central processing units (CPUs), an input/output interface, a network interface, and a memory.

The memory may include computer readable media such as a volatile memory, a Random-Access Memory (RAM), and/or non-volatile storage device, e.g., a Read-Only Memory (ROM) or a flash RAM. The memory is an example of a computer readable medium.

The computer readable medium includes non-volatile and volatile media as well as movable and non-movable media and may implement information storage by means of any method or technology. The information may be a computer readable instruction, a data structure, and a module of a program or other data. An example of the storage medium of a computer includes, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission medium, and may be used to store information accessible to the computing device. According to the definition in this text, the computer readable medium does not include transitory media, such as a modulated data signal and a carrier.

It should be further noted that terms “include” and “comprise” as well as their any other variations are intended to cover non-exclusive inclusion, so that a process, method, commodity or device including a series of elements not only includes the elements clearly listed, but also may include other elements not clearly listed or elements inherent to the process, method, commodity or device. Without more restrictions, other identical elements may also exist in the process, method, commodity or device including the element defined by the phrase “including a . . . ”.

Example embodiments are described in detail here, which are illustrated in the accompanying drawings. When the following description is related to the drawings, identical numerals in different drawings represent identical or similar elements, unless otherwise indicated. The implementations described in the following example embodiments do not represent all implementations consistent with the present disclosure. On the contrary, they are merely some examples of devices and methods consistent with some aspects of the present disclosure as detailed in the appended claims.

The terms used in the present disclosure are merely used for describing specific example embodiments and are not intended to limit the present disclosure. The terms “a(n),” “said” and “the” initiating the singular form are also intended to include the plural form, unless other meanings are clearly indicated in the context. It should be further understood that the term “and/or” used in this text means any or all possible combinations including one or more associated items listed.

It should be understood that although terms such as “first,” “second” and “third” may be used in the present disclosure to describe various information, the information should not be limited to the foregoing terms. The terms are only used to distinguish information of the same type from one another. For example, without departing from the scope of the present disclosure, first information may also be referred to as second information, and similarly, second information may also be referred to as first information. For example, the term “if” used here may be interpreted as “when,” “upon” or “in response to the determination” depending on the context.

The above description includes merely example embodiments of this specification and is not used to limit this specification. Any modification, equivalent replacement, improvement and the like made without departing from the spirit and principle of this specification should fall within the protection scope of this specification.

The present disclosure may further be understood with clauses as follows.

Clause 1. A communication method comprising:

detecting a user operation aimed at a trigger element related to a reminder message function page in a communication application;

executing a regular processing function corresponding to the trigger element when the user operation is a predefined regular trigger operation; and

displaying a quick editing page for a reminder message when the user operation is a predefined quick trigger operation, the quick editing page being used for quickly sending received user input information as a content of the reminder message according to a default sending condition.

Clause 2. The method of clause 1, wherein:

the regular trigger operation comprises a click operation for the trigger element and the quick trigger operation comprises a long-press operation for the trigger element; or

the regular trigger operation comprises a tap operation for the trigger element and the quick trigger operation comprises a hit operation for the trigger element.

Clause 3. The method of clause 1, wherein the executing the regular processing function corresponding to the trigger element when the user operation is the predefined regular trigger operation comprises:

switching to the reminder message function page according to the regular trigger operation when the trigger element comprises a first entry identifier of the reminder message function page in the communication application.

Clause 4. The method of clause 1, wherein the executing the regular processing function corresponding to the trigger element when the user operation is the predefined regular trigger operation comprises:

displaying a normal editing page for the reminder message according to the regular trigger operation when the trigger element comprises a second entry identifier of the normal editing page for the reminder message, the second entry identifier being located in the reminder message function page;

determining the content of the reminder message according to user input information received in the reminder message function page, and completing a user configuration for the sending condition; and

sending the content of the reminder message normally according to the user-configured sending condition.

Clause 5. The method of clause 1, wherein the sending condition comprises:

a receiver of the reminder message; and

a message type of the reminder message.

Clause 6. The method of clause 5, wherein the receiver of the reminder message is a sender of the reminder message by default.

Clause 7. The method of clause 1, further comprising:

when the quick editing page comprises a mode switching identifier, configuring the reminder message to be in a corresponding presentation mode according to a trigger operation for the mode switching identifier,

wherein:

a reminder message in a pin-to-top mode is presented in a first presentation area in a reminder message presentation page corresponding to a receiver;

a reminder message in a common mode is presented in a second presentation area in the reminder message presentation page corresponding to the receiver, the first presentation area being different from the second presentation area.

Clause 8. The method of clause 1, wherein the displaying the quick editing page for the reminder message comprises displaying the quick editing page in a temporary pop-up window which is closed automatically after the reminder message is sent.

Clause 9. A communication device comprising:

a detecting unit configured to detect a user operation aimed at a trigger element related to a reminder message function page in a communication application;

an executing unit configured to execute a regular processing function corresponding to the trigger element when the user operation is a predefined regular trigger operation; and

a displaying unit configured to display a quick editing page for a reminder message when the user operation is a predefined quick trigger operation, the quick editing page being used for quickly sending received user input information as a content of the reminder message according to a default sending condition.

Clause 10. The device of clause 9, wherein:

the regular trigger operation comprises a click operation for the trigger element and the quick trigger operation comprises a long-press operation for the trigger element; or

the regular trigger operation comprises a tap operation for the trigger element and the quick trigger operation comprises a hit operation for the trigger element.

Clause 11. The device of clause 9, wherein the executing unit is configured to:

switch to the reminder message function page according to the detected regular trigger operation when the trigger element comprises a first entry identifier of the reminder message function page in the communication application.

Clause 12. The device of clause 9, wherein the executing unit is configured to:

display a normal editing page for the reminder message according to the detected regular trigger operation when the trigger element comprises a second entry identifier of the normal editing page for the reminder message, the second entry identifier being located in the reminder message function page;

determine the content of the reminder message according to user input information received in the reminder message function page, and complete user configuration for a sending condition; and

send the content of the reminder message normally according to the user-configured sending condition.

Clause 13. The device of clause 9, wherein the sending condition comprises:

a receiver of the reminder message; and

a message type of the reminder message.

Clause 14. The device of clause 13, wherein the receiver of the reminder message is a sender of the reminder message by default.

Clause 15. The device of clause 9, further comprising:

a configuring unit configured to, when the quick editing page comprises a mode switching identifier, configure the reminder message to be in a corresponding presentation mode according to a trigger operation for the mode switching identifier,

wherein:

a reminder message in a pin-to-top mode is presented in a first presentation area in a reminder message presentation page corresponding to a receiver; and

a reminder message in a common mode is presented in a second presentation area in the reminder message presentation page corresponding to the receiver, the first presentation area being different from the second presentation area.

Clause 16. The device of clause 9, wherein the displaying unit is configured to display the quick editing page in a temporary pop-up window which is closed automatically after the reminder message is sent.

What is claimed is:

1. A method comprising:
detecting a user operation aimed at a trigger element related to a reminder message function page in a communication application; and
displaying a quick editing page for a reminder message when the user operation is a predefined quick trigger operation, the quick editing page being used for sending received user input information as a content of the reminder message according to a default sending condition.

2. The method of claim 1, further comprising:
executing a regular processing function corresponding to the trigger element in response to determining that the user operation is a predefined regular trigger operation.

3. The method of claim 2, wherein:
the regular trigger operation comprises a tap operation for the trigger element; and
the quick trigger operation comprises a hit operation for the trigger element.

4. The method of claim 2, wherein:
the regular trigger operation comprises a click operation for the trigger element; and
the quick trigger operation comprises a long-press operation for the trigger element.

5. The method of claim 2, wherein the executing the regular processing function corresponding to the trigger element in response to determining that the user operation is the predefined regular trigger operation comprises:
switching to the reminder message function page according to the regular trigger operation when the trigger element comprises a first entry identifier of the reminder message function page in the communication application.

6. The method of claim 2, wherein the executing the regular processing function corresponding to the trigger element in response to determining that the user operation is the predefined regular trigger operation comprises:
displaying a normal editing page for the reminder message according to the regular trigger operation when the trigger element comprises a second entry identifier of the normal editing page for the reminder message, the second entry identifier being located in the reminder message function page;
determining the content of the reminder message according to user input information received in the reminder message function page, and completing a user configuration for the sending condition; and
sending the content of the reminder message normally according to the user-configured sending condition.

7. The method of claim 1, wherein the sending condition comprises:
a receiver of the reminder message; and
a message type of the reminder message.

8. The method of claim 7, wherein the receiver of the reminder message is a sender of the reminder message by default.

9. The method of claim 1, further comprising:
determining that the quick editing page comprises a mode switching identifier; and
configuring the reminder message to be in a corresponding presentation mode according to a trigger operation for the mode switching identifier.

10. The method of claim 9, wherein:
a reminder message in a pin-to-top mode is presented in a first presentation area in a reminder message presentation page corresponding to a receiver; and
a reminder message in a common mode is presented in a second presentation area in the reminder message presentation page corresponding to the receiver, the first presentation area being different from the second presentation area.

11. The method of claim 1, wherein the displaying the quick editing page for the reminder message comprises displaying the quick editing page in a temporary pop-up window which is closed automatically after the reminder message is sent.

12. A device comprising:
one or more processors; and
one or more memories storing thereon computer-readable instructions that, when executed by the one or more processors, cause the one or more processors to perform acts comprising:
detecting a user operation aimed at a trigger element related to a reminder message function page in a communication application; and
displaying a quick editing page for a reminder message when the user operation is a predefined quick trigger operation, the quick editing page being used for sending received user input information as a content of the reminder message according to a default sending condition.

13. The device of claim 12, wherein the acts further comprise executing a regular processing function corresponding to the trigger element in response to determining that the user operation is a predefined regular trigger operation.

14. The device of claim 13, wherein:
the regular trigger operation comprises a click operation for the trigger element; and
the quick trigger operation comprises a long-press operation for the trigger element.

15. The device of claim 13, wherein:
the regular trigger operation comprises a tap operation for the trigger element; and
the quick trigger operation comprises a hit operation for the trigger element.

16. The device of claim 13, wherein the executing the regular processing function corresponding to the trigger element in response to determining that the user operation is the predefined regular trigger operation comprises:
switching to the reminder message function page according to the regular trigger operation when the trigger element comprises a first entry identifier of the reminder message function page in the communication application.

17. The device of claim 13, wherein the executing the regular processing function corresponding to the trigger element in response to determining that the user operation is the predefined regular trigger operation comprises:
displaying a normal editing page for the reminder message according to the regular trigger operation when the trigger element comprises a second entry identifier of the normal editing page for the reminder message, the second entry identifier being located in the reminder message function page;
determining the content of the reminder message according to user input information received in the reminder message function page, and completing a user configuration for the sending condition; and
sending the content of the reminder message normally according to the user-configured sending condition.

18. The device of claim 12, wherein the sending condition comprises:
a receiver of the reminder message; and
a message type of the reminder message.

19. The device of claim 11, further comprising:
determining that the quick editing page comprises a mode switching identifier; and
configuring the reminder message to be in a corresponding presentation mode according to a trigger operation for the mode switching identifier, wherein:
a reminder message in a pin-to-top mode is presented in a first presentation area in a reminder message presentation page corresponding to a receiver; and
a reminder message in a common mode is presented in a second presentation area in the reminder message presentation page corresponding to the receiver, the first presentation area being different from the second presentation area.

20. One or more memories storing thereon computer-readable instructions that, when executed by the one or more processors, cause the one or more processors to perform acts comprising:
detecting a user operation aimed at a trigger element related to a reminder message function page in a communication application;
displaying a quick editing page for a reminder message when the user operation is a predefined quick trigger operation, the quick editing page being used for sending received user input information as a content of the reminder message according to a default sending condition.
determining that the quick editing page comprises a mode switching identifier; and
configuring the reminder message to be in a corresponding presentation mode according to a trigger operation for the mode switching identifier,
wherein:
a reminder message in a pin-to-top mode is presented in a first presentation area in a reminder message presentation page corresponding to a receiver; and
a reminder message in a common mode is presented in a second presentation area in the reminder message presentation page corresponding to the receiver, the first presentation area being different from the second presentation area.
